(19) United States
(12) Patent Application Publication
(10) Pub. No.: US 2019/0296833 A1
(43) Pub. Date: Sep. 26, 2019

(54) TERMINAL APPARATUS AND APPARATUS SYSTEM

(71) Applicant: Sony Semiconductor Solutions Corporation, Kanagawa (JP)

(72) Inventors: Tatsuki Amimoto, Tokyo (JP); Kenichi Kobayashi, Tokyo (JP)

(21) Appl. No.: 16/304,473

(22) PCT Filed: Jun. 14, 2017
(86) PCT No.: PCT/JP2017/021929

§ 371 Date: Nov. 26, 2018

(30) Foreign Application Priority Data
Jul. 27, 2016 (JP) 2016-147119

(51) Int. Cl. H04B 13/00; H04L 29/08; H04L 12/26

(52) U.S. Cl. CPC H04B 13/005; H04L 43/08; H04L 67/18

(57) ABSTRACT

A terminal apparatus of the disclosure includes a communication unit that performs communication, using a human body as a communication medium, with a communicated terminal apparatus, and a first position determination section that determines a position of the communicated terminal apparatus, on a basis of a communication state between the communicated terminal apparatus and the communication unit.

### TECHNICAL FIELD

The disclosure relates to a terminal apparatus and an apparatus system that utilize communication using a human body as a communication medium (human body communication).

### BACKGROUND ART

There is known a communication unit that utilizes an electric field communication technology using, for example, a human body as a communication medium. There is developed a technology of mounting such a communication unit on various terminal apparatuses including a wristband apparatus, a smartphone, a speaker, etc., and performing communication between a plurality of terminal apparatuses.

### CITATION LIST

### Patent Literature

PTL 1: Japanese Unexamined Patent Application Publication No. 2004-328542

PTL 2: Japanese Unexamined Patent Application Publication No. 2013-157789

### SUMMARY OF THE INVENTION

It is conceivable that positional information of a terminal apparatus mounted with the above-described communication unit be applied to various use forms.

It is desirable to provide a terminal apparatus and an apparatus system that make it possible to determine a position of a communication partner by utilizing a human body communication technology.

A terminal apparatus according to an embodiment of the disclosure includes: a communication unit that performs communication, using a human body as a communication medium, with a communicated terminal apparatus; and a first position determination section that determines a position of the communicated terminal apparatus, on a basis of a communication state between the communicated terminal apparatus and the communication unit.

An apparatus system according to an embodiment of the disclosure includes: a first terminal apparatus; and a second terminal apparatus that performs communication with the first terminal apparatus, the first terminal apparatus including a communication unit that performs communication, using a human body as a communication medium, with the second terminal apparatus, and a position determination section that determines a position of the second terminal apparatus, on a basis of a communication state between the second terminal apparatus and the communication unit.

In the terminal apparatus or the apparatus system according to the embodiment of the disclosure, a position of a communication partner is determined on the basis of the state of the communication using the human body as the communication medium.

According to the terminal apparatus or the apparatus system in the embodiment of the disclosure, because the position of the communication partner is determined on the basis of the state of the communication using the human body as the communication medium, it is possible to determine the position of the communication partner by utilizing a human body communication technology.

It is to be noted that effects described here are not necessarily limitative, and may be any of effects described in the disclosure.

### BRIEF DESCRIPTION OF DRAWINGS

FIG. 1 is a configuration diagram illustrating an overview of a communication system according to a comparative example that utilizes an electric field communication technology and uses a human body as a communication medium.

FIG. 2 is a configuration diagram illustrating an overview of the communication system according to the comparative example.

FIG. 3 is an explanatory diagram about pairing of speakers.

FIG. 4 is a block diagram schematically illustrating a configuration example of a terminal apparatus according to a first embodiment of the disclosure.

FIG. 5 is an explanatory diagram schematically illustrating a first application example of the terminal apparatus and an apparatus system according to the first embodiment.

FIG. 6 is an explanatory diagram schematically illustrating a second application example of the terminal apparatus and the apparatus system according to the first embodiment.

FIG. 7 is an explanatory diagram schematically illustrating a fourth application example of the terminal apparatus and the apparatus system according to the first embodiment.

FIG. 8 is an explanatory diagram schematically illustrating the fourth application example of the terminal apparatus and the apparatus system according to the first embodiment.

FIG. 9 is an explanatory diagram schematically illustrating the fourth application example of the terminal apparatus and the apparatus system according to the first embodiment.

FIG. 10 is an explanatory diagram schematically illustrating the fourth application example of the terminal apparatus and the apparatus system according to the first embodiment.

FIG. 11 is a block diagram depicting an example of schematic configuration of a vehicle control system.

FIG. 12 is a diagram of assistance in explaining an example of installation positions of an outside-vehicle information detecting section and an imaging section.

### MODES FOR CARRYING OUT THE INVENTION

Some embodiments of the disclosure are described below in detail with reference to the drawings. It is to be noted that the description is given in the following order.

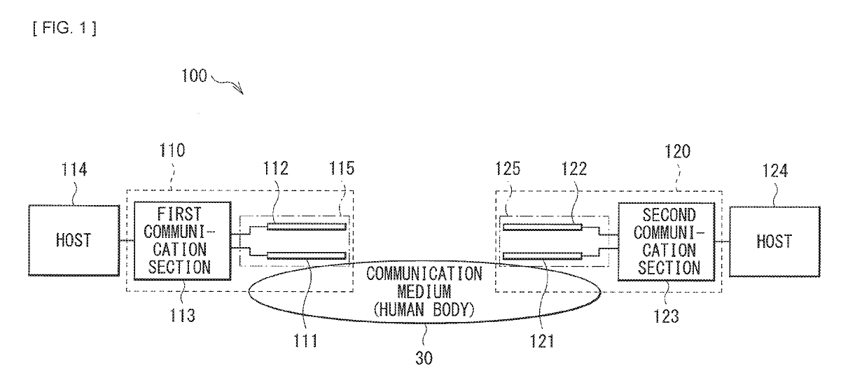

0. Comparative Example (an overview and an issue of a communication system that uses a human body as a communication medium) (FIG. 1 to FIG. 3)
1. First Embodiment (a terminal apparatus having a position determination function that utilizes human body communication)

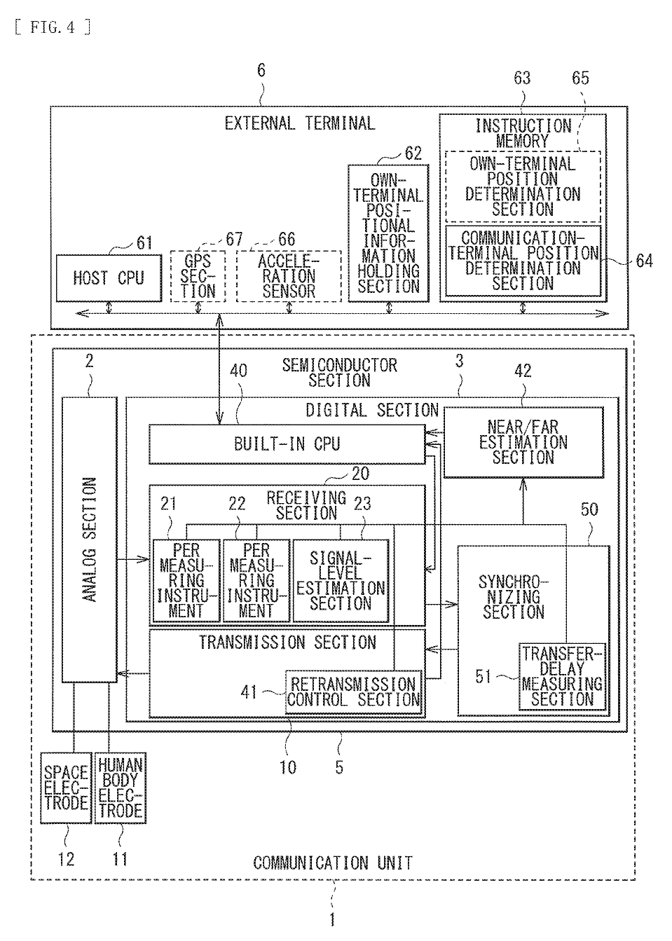

1.1 Configuration and Operation of Terminal Apparatus and Apparatus System According To First Embodiment (FIG. 4)

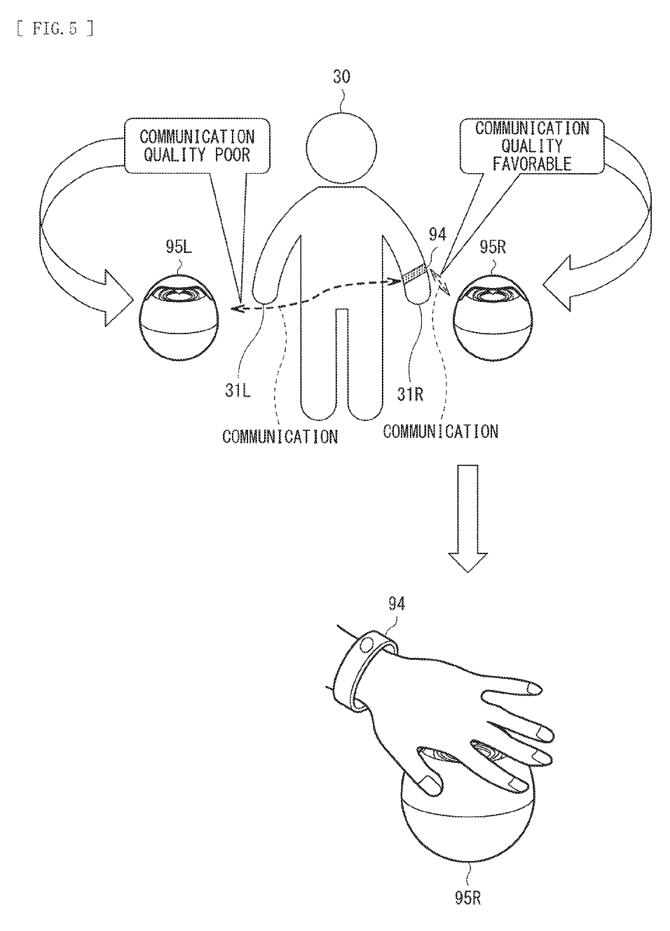

1.2 Application Examples of Terminal Apparatus and Apparatus System (FIG. 5 to FIG. 10)

1.3 Effects

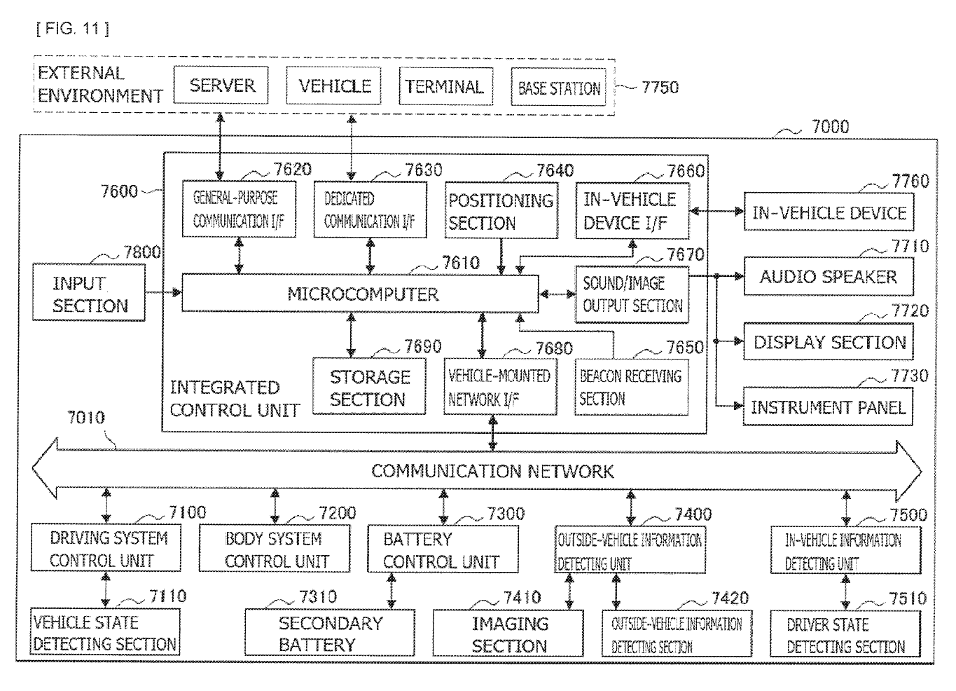

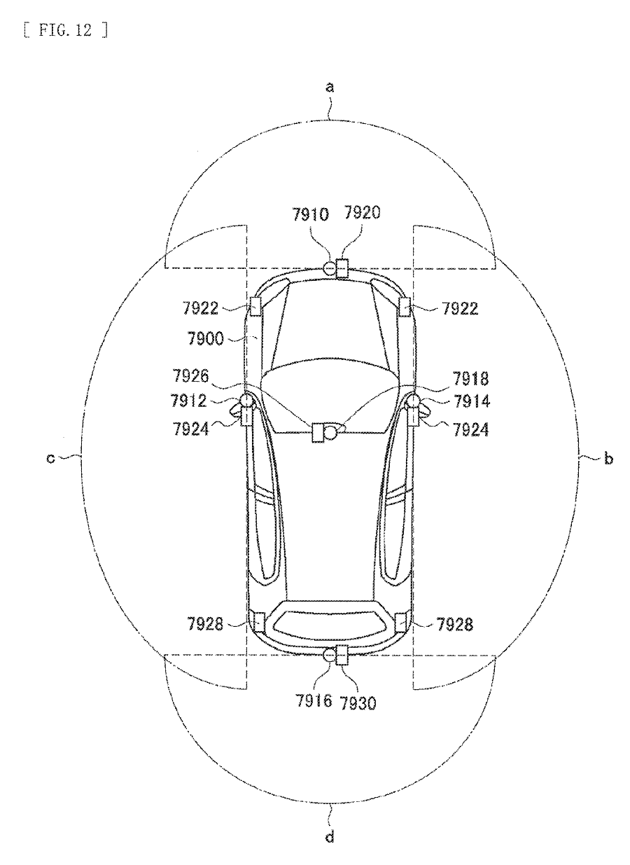

2. Second Embodiment (an example of application to a mobile body) (FIG. 11 and FIG. 12)

### 3. Other Embodiments

### 0. Comparative Example

### (Overview of Communication System Using Human Body as Communication Medium)

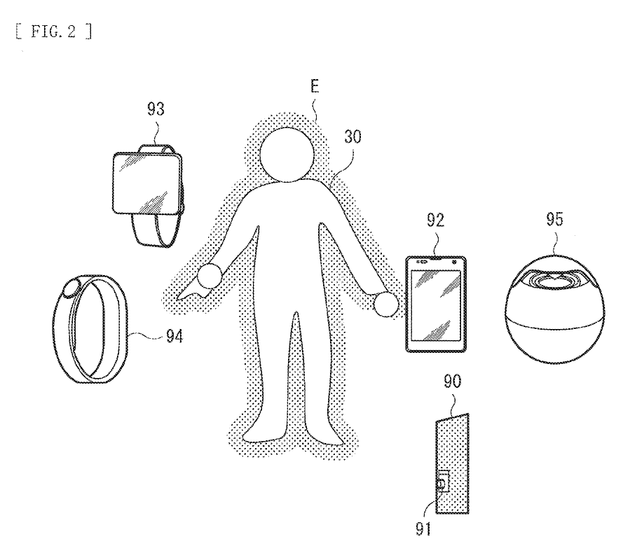

FIG. 1 and FIG. 2 each illustrate an overview of a communication system according to a comparative example that utilizes an electric field communication technology and uses a human body 30 as a communication medium.

A communication system 100 according to this comparative example includes a first communication unit 110 and a second communication unit 120.

It is possible to utilize the communication system 100 for, for example, an apparatus system that includes a first terminal apparatus possessed by the human body 30 and a communicated terminal apparatus (a second terminal apparatus) that communicates with the first terminal apparatus through the human body 30. In this case, for example, the first terminal apparatus may be a wearable apparatus such as a smartwatch 93, a wristband terminal 94, etc., as illustrated in, for example, FIG. 2. Further, the second terminal apparatus may be a communication apparatus for authentication mounted on a doorknob 91 of a door 90, or an electronic apparatus such as a smartphone 92, a speaker 95, etc. For example, either one of the first communication unit 110 and the second communication unit 120 may be provided at the first terminal apparatus such as the wristband terminal 94, etc., and the other may be provided at the second terminal apparatus such as the smartphone 92, the speaker 95, etc.

The first communication unit 110 has a first antenna section 115 and a first communication section 113. The first antenna section 115 has a first human body electrode 111 and a first space electrode 112. The first communication section 113 is coupled to a host 114.

The second communication unit 120 has a second antenna section 125 and a second communication section 123. The second antenna section 125 has a second human body electrode 121 and a second space electrode 122. The second communication section 123 is coupled to a host 124.

The first communication section 113 and the second communication section 123 each include a communication circuit employing an electric field communication system.

The first communication section 113 may include at least a transmission circuit. The second communication section 123 may include at least a receiving circuit. The first communication section 113 and the second communication section 123 may each have a transmitter-receiver circuit, and interactive communication may be enabled between the first communication unit 110 and the second communication unit 120.

In a case where a signal is transmitted from the first communication unit 110, the first communication section 113 generates a transmission signal of a potential difference including a signal modulated by a predetermined modulation system, between the first human body electrode 111 and the first space electrode 112. The first human body electrode 111 is disposed on side closer to the human body 30 than the first space electrode 112. The first human body electrode 111 is thereby disposed to have stronger capacitive coupling to the communication medium (the human body) 30 than the first space electrode 112.

In this communication system, a part of the human body 30 is closer to the second human body electrode 121 than to the second space electrode 122, and a human-body side communication path that uses the human body 30 as a communication medium 30 is thereby formed between the first human body electrode 111 and the second human body electrode 121. In addition, a space-side communication path that uses a space (e.g., air) as a communication medium is formed between the first space electrode 112 and the second space electrode 122.

A potential difference corresponding to a transmission signal transferred through the communication medium (the human body) 30 is generated between the second human body electrode 121 and the second space electrode 122. The second communication section 123 detects the potential difference generated between the second human body electrode 121 and the second space electrode 122, assumes the detected potential difference to be a receiving signal by performing demodulation processing corresponding to the modulation system of the first communication section 113, and outputs the receiving signal as an output signal.

In the electric field communication, as a person touches or approaches a human body electrode, an electric field E is distributed over a human body surface to thereby perform communication, as illustrated in FIG. 2. For this reason, communication is enabled only in extreme proximity to the human body 30. In addition, compatibility with a wearable device is high.

Examples of a standard of the electric field communication as described above include ISO/IEC 17982 CCCC PHY (Closed Capacitive Coupling Communication Physical Layer). In the ISO/IEC 17982 CCCC PHY, automatic retransmission control (ARQ: Automatic Repeat reQuest) using error detecting code and retransmission control is adopted.

### (Issue)

It is conceivable that positional information of a terminal apparatus mounted with a communication unit that utilizes the above-described electric field communication technology be applied to various use forms.

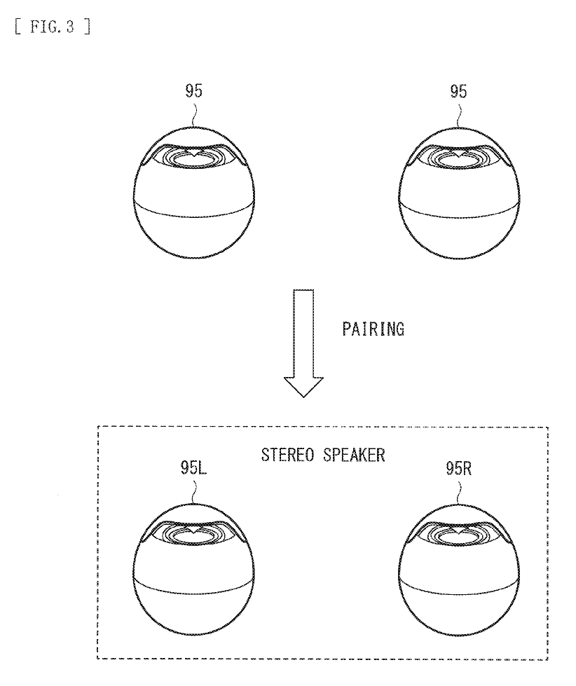

For example, as illustrated in FIG. 3, in a case where the speaker 95 is a monaural speaker, there is such a technology that two speakers 95 are combined to be utilized, as a whole, as a stereo speaker, by providing one as a right speaker 95R and the other as a left speaker 95L. Such a technology is called stereo pairing. In a typical stereo pairing technology, it is necessary to perform a complicated procedure such as specifying and selecting which one of the two speakers 95 is to be the right speaker 95R or the left speaker 95L, by operating operation buttons mounted on the two speakers 95, an operation button of a reproduction apparatus coupled to the two speakers 95, etc., and it takes some time before completion of pairing, in many cases.

In such a case, development of a technology that enables automatic distinguishing between right and left positions of the two speakers 95 is expected. Hence, as illustrated in FIG. 5 described later, the disclosure provides a technology of configuring, for example, the wristband terminal 94 and the two speakers 95 to be able to communicate with each other by a human body communication technology, and enabling automatic distinguishing between the right and left positions of the two speakers 95.

Further, in the disclosure, there is also described an example of application of the position distinguishing technology using the human body communication technology to various use forms other than the stereo pairing.

### 1. First Embodiment

### [1.1 Configuration and Operation of Terminal Apparatus and Apparatus System According to First Embodiment]

### (Configuration of Terminal Apparatus)

FIG. 4 schematically illustrates a configuration example of a terminal apparatus according to a first embodiment of the disclosure.

The terminal apparatus according to the present embodiment may be a terminal apparatus having a position determination function that utilizes human body communication. The terminal apparatus according to the present embodiment may be applied to the first terminal apparatus described in the foregoing comparative example, e.g., the wristband terminal 94, etc. attached to a hand (an arm) of the human body 30. Further, the terminal apparatus according to the present embodiment may be configured to communicate with the communicated terminal apparatus (the second terminal apparatus) described in the foregoing comparative example. The second terminal apparatus may be an electronic apparatus such as the speaker 95, etc. An apparatus system according to the present embodiment may include at least these first and second terminal apparatuses.

The terminal apparatus according to the present embodiment includes a communication unit 1 and an extemal terminal 6.

The communication unit 1 may be applied to either one of the first communication unit 110 and the second communication unit 120 in the communication system 100 according to the foregoing comparative example.

The communication unit 1 includes an analog section 2, a digital section 3, a human body electrode 11, and a space electrode 12. The analog section 2 and the digital section 3 may be provided within one semiconductor unit (an IC), as a semiconductor section 5.

The human body electrode 11 and the space electrode 12 may be configured similarly to the first human body electrode 111 and the first space electrode 112, or the second human body electrode 121 and the second space electrode 122, in the communication system 100 according to the foregoing comparative example.

A transmission signal from the communicated terminal apparatus is inputted to the analog section 2 through the human body electrode 11 and the space electrode 12. Further, the analog section 2 outputs a transmission signal to the communicated terminal apparatus through the human body electrode 11 and the space electrode 12. The analog section 2 may have a filter, etc. that limits a signal band.

The digital section 3 has a receiving section 20, a transmission section 10, a synchronizing section 50, a near-far estimation section 42, and a built-in CPU (Central Processing Unit) 40.

The receiving section 20 has a PER (packet error rate) measuring instrument 21, a BER (bit error rate) measuring instrument 22, and a signal-level estimation section 23 inside the receiving section 20.

The transmission section 10 has a retransmission control section 41 inside the transmission section 10.

The synchronizing section 50 has a transfer-delay measuring section 51 inside the synchronizing section 50.

The PER measuring instrument 21, the BER measuring instrument 22, the signal-level estimation section 23, and the transfer-delay measuring section 51 may each be a measuring section that measures a communication state between the communicated terminal apparatus and the communication unit 1. Here, the communication state to be measured by the measuring section may include at least one of a packet error rate, a bit error rate, a signal level, and a transfer delay amount of transfer data transferred between the communicated terminal apparatus and the communication unit.

The external terminal 6 has a Host CPU 61, an own-terminal positional information holding section 62, and an instruction memory 63.

The instruction memory 63 has a communication-terminal position determination section 64. The communication-terminal position determination section 64 may be provided as a program allowed to be executed by the Host CPU 61.

The communication-terminal position determination section 64 may be a first position determination section that determines a position of the communicated terminal apparatus, on the basis of the communication state between the communicated terminal apparatus and the communication unit 1. The communication-terminal position determination section 64 may determine a relative position of the communicated terminal apparatus with respect to an installation location of an own terminal. The communication-terminal position determination section 64 may determine a right-left position, as the relative position of the communicated terminal apparatus.

Further, for example, in a case where the communicated terminal apparatus includes a first communicated terminal apparatus and a second communicated terminal apparatus, the communication-terminal position determination section 64 may determine a relative position of the first communicated terminal apparatus and the second communicated terminal apparatus. Here, the first communicated terminal apparatus and the second communicated terminal apparatus may be, for example, two electronic apparatuses such as the two speakers 95, etc. to be subjected to stereo pairing.

The external terminal 6 may have an acceleration sensor 66 and a GPS (Global Positioning System) section 67. The GPS section 67 may be able to position an absolute location of the own terminal.

The external terminal 6 may have an own-terminal position determination section 65 that may use the acceleration sensor 66 or the GPS section 67. The own-terminal position determination section 65 may be provided as a program allowed to be executed by the Host CPU 61.

The own-terminal positional information holding section 62 may be a storage section that stores information of an installation location of the own terminal. The own-terminal positional information holding section 62 may store information of an absolute location or a relative position of the own terminal as the information of the installation location of the own terminal. The absolute location of the own terminal may be positioning information using the GPS section 67. The relative position of the own terminal may be a relative installation location in the human body 30 to which the own terminal is attached. The relative position of the own terminal may be a position that includes at least one of a right-left position, a front-back position, and an upper-lower position, in the human body 30 to which the own terminal is attached.

### (Operation of Terminal Apparatus)

In this terminal apparatus, a transmission signal from the communicated terminal apparatus received through the human body electrode 11 and the space electrode 12 is outputted by the analog section 2 as a digital receiving signal to the receiving section 20.

Further, in this terminal apparatus, a digital transmission signal is outputted from the transmission section 10 to the analog section 2. The analog section 2 transmits the digital transmission signal as an analog transmission signal to the communicated terminal apparatus through the human body electrode 11 and the space electrode 12.

Reception timing information of a receiving signal is outputted from the receiving section 20 to the synchronizing section 50.

Transmission timing information of a transmission signal is outputted from the synchronizing section 50 to the transmission section 10.

Transmission data is outputted from the built-in CPU 40 to the transmission section 10.

Receiving data is outputted from the receiving section 20 to the built-in CPU 40.

Data of a packet error rate is outputted from the PER measuring instrument 21 to the near-far estimation section 42. Data of a bit error rate is outputted from the BER measuring instrument 22 to the near-far estimation section 42. Data of a signal level estimation value is outputted from the signal-level estimation section 23 to the near-far estimation section 42.

Data of the number of retransmissions is outputted from the retransmission control section 41 to the near-far estimation section 42.

Data of a transmission reception delay amount (a transfer delay amount) is outputted from the transfer-delay measuring section 51 to the near-far estimation section 42.

Data of a near-far estimation value is outputted from the near-far estimation section 42 to the built-in CPU 40.

Using the own-terminal position determination section 65 stored in the instruction memory 63 and the acceleration sensor 66 or the GPS section 67, the Host CPU 61 may, for example, estimate to which one of right and left hands the own terminal is attached, and hold a result of the estimation in the own-terminal positional information holding section 62, as the information of the installation location of the own terminal.

The transmission section 10 receives transmission data from the built-in CPU 40, and sends out a transmission signal to the analog section 2, on the basis of transmission timing from the synchronizing section 50. The transmission section 10 performs retransmission control using the retransmission control section 41, upon transmission.

The receiving section 20 receives a receiving signal from the analog section 2, and outputs receiving data to the built-in CPU 40. Further, the receiving section 20 outputs reception timing to the synchronizing section 50. At the time, measurement and estimation of a packet error rate, a bit error rate, a signal level, etc. at the time of reception are performed.

The synchronizing section 50 decides the next transmission timing, according to the reception timing. At the time, the synchronizing section 50 measures a transmission reception delay amount (a transfer delay amount) from the transmission timing and the reception timing, using the transfer-delay measuring section 51.

On the basis of a value measured and estimated in each of the transmission section 10, the receiving section 20, and the synchronizing section 50, the near-far estimation section 42 creates a near-far estimation value to determine whether the communicated terminal apparatus is near or far, and notifies the Host CPU 61 of the near-far estimation value through the built-in CPU 40.

In the Host CPU 61, the position of the communicated terminal apparatus such as the speaker 95, etc., for example, the right-left position, is determined on the basis of the near-far estimation value and the information of the own-terminal positional information holding section 62, by the communication-terminal position determination section 64.

### [1.2 Application Examples of Terminal Apparatus and Apparatus System]

Described below are examples in which the terminal apparatus and the apparatus system according to the present embodiment described above are applied to various use forms.

### (First Application Example)

FIG. 5 schematically illustrates a first application example of the terminal apparatus and the apparatus system according to the present embodiment.

FIG. 5 illustrates an example in which the terminal apparatus and the apparatus system according to the present embodiment are applied to stereo pairing of providing either one of the two speakers 95 as the right speaker 95R or the left speaker 95L.

FIG. 5 illustrates an example in which the wristband terminal 94 is attached as the terminal apparatus on, for example, a right hand 31R side of the human body 30. Further, FIG. 5 illustrates an example in which the two speakers 95 each to be the right speaker 95R or the left speaker 95L are provided as the communicated terminal apparatus.

As illustrated in FIG. 5, in the case where the terminal apparatus is attached on the right hand 31R side, a case where the communicated terminal apparatus is touched with the right hand 31R achieves a short communication path and thus provides favorable communication quality, as compared with a case where the communicated terminal apparatus is touched with a left hand 31L. Further, the terminal apparatus according to the present embodiment stores the information of the installation location of the own terminal as described above. For this reason, it is possible to distinguish whether the communicated terminal apparatus is touched with the right hand 31R or the communicated terminal apparatus is touched with the left hand 31L, by determining whether the communication quality is relatively poor or favorable. This makes it possible to execute, in the example in FIG. 5, stereo pairing by providing the one touched with the right hand 31R as the right speaker 95R and providing the one touched with the left hand 31L as the left speaker 95L.

It is to be noted that it is possible to determine the communication quality, on the basis of the communication state measured by the above-described measuring section, e.g., a packet error rate, a bit error rate, a signal level, a transfer delay amount, etc.

### (Second Application Example)

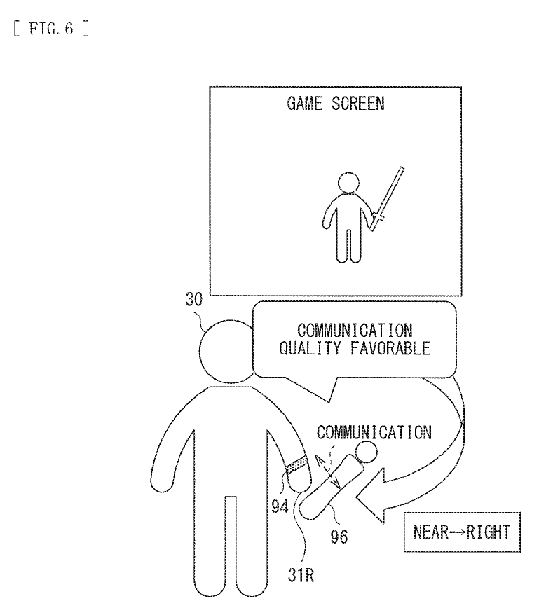

FIG. 6 schematically illustrates a second application example of the terminal apparatus and the apparatus system according to the present embodiment.

FIG. 6 illustrates an example in which the wristband terminal 94 is attached as the terminal apparatus on, for example, the right hand 31R side of the human body 30. Further, FIG. 6 illustrates an example in which a controller 96 for game is provided as the communicated terminal apparatus.

As with the foregoing first application example, the wristband terminal 94 is able to distinguish which one of the left hand 31L and the right hand 31R is a hand holding the controller 96, on the basis of communication quality of communication with the communicated terminal apparatus. It is to be noted that FIG. 6 illustrates an example in which the communication quality is detected as favorable quality and the right hand 31R is distinguished as the hand holding the controller 96.

Information resulting from such right-left determination may be reflected on a content of the game. For example, in a case of a game in which the controller 96 is set as a sword, a game image in which the sword is held with a hand on the same side as that of the hand holding the controller 96 may be displayed on a game screen.

It is to be noted that it is possible to perform right-left determination for various types of communicated terminal apparatuses, without being limited to such a controller 96 for game. For example, which one of right and left hands is a touching hand may be distinguished by providing a tablet apparatus or a touchable digital signage apparatus as the communicated terminal apparatus, and performing human body communication at the start of use of the tablet apparatus, etc. In this case, on the basis of a result of right-left determination, the tablet apparatus, etc. may be customized for a right-handed person or a left-handed person.

Similarly, a mouse of a PC (a personal computer) may be provided as the communicated terminal apparatus, and which one of right and left hands is a hand touching the mouse may be distinguished. In this case, on the basis of a result of right-left determination, setting for the mouse may be switched for a right-handed person or a left-handed person, on the PC side. For example, in a case where the mouse is provided with a plurality of buttons, a function to be assigned to a button may be changed on the basis of a result of right-left determination such that a button corresponding to a forefinger is a decision button, and a button corresponding to a middle finger is another menu button, etc.

### (Third Application Example)

The apparatus system according to the present embodiment may be applied to, for example, the first terminal apparatus including a positioning IC and a human body communication IC, and the second terminal apparatus including the human body communication IC without the positioning IC. For example, a position of the second terminal apparatus without positioning IC may be estimated on condition that communication quality between the first terminal apparatus and the second terminal apparatus is favorable. For example, a determination may be made in which the second terminal apparatus is present at a position with an error of less than 1 m with respect to the first terminal apparatus, etc. This may allow for a recognition that, for example, a position determined by positioning data of the positioning IC in the first terminal apparatus+the position with the error of less than 1 m is the position of the second terminal apparatus.

### (Fourth Application Example)

FIG. 7 to FIG. 10 schematically illustrate a fourth application example of the terminal apparatus and the apparatus system according to the present embodiment.

FIG. 7 to FIG. 10 each illustrate an example in which a first terminal holder 30A and a second terminal holder 30B each have the wristband terminal 94 being attached as the terminal apparatus on the left hand 31L side or the right hand 31R side.

FIG. 7 illustrates an example in which the first terminal holder 30A and the second terminal holder 30B each have the wristband terminal 94 being attached as the terminal apparatus on the left hand 31L side. The first terminal holder 30A and the second terminal holder 30B both have the wristband terminals 94 being attached as the terminal apparatuses on the left hand 31L sides, and thus, in a case where the two terminal apparatuses perform communication of poor quality with each other, the terminal apparatuses are able to recognize that the respective right hands 31R each on the side opposite to the side where the terminal apparatus is attached are used for shaking-hands.

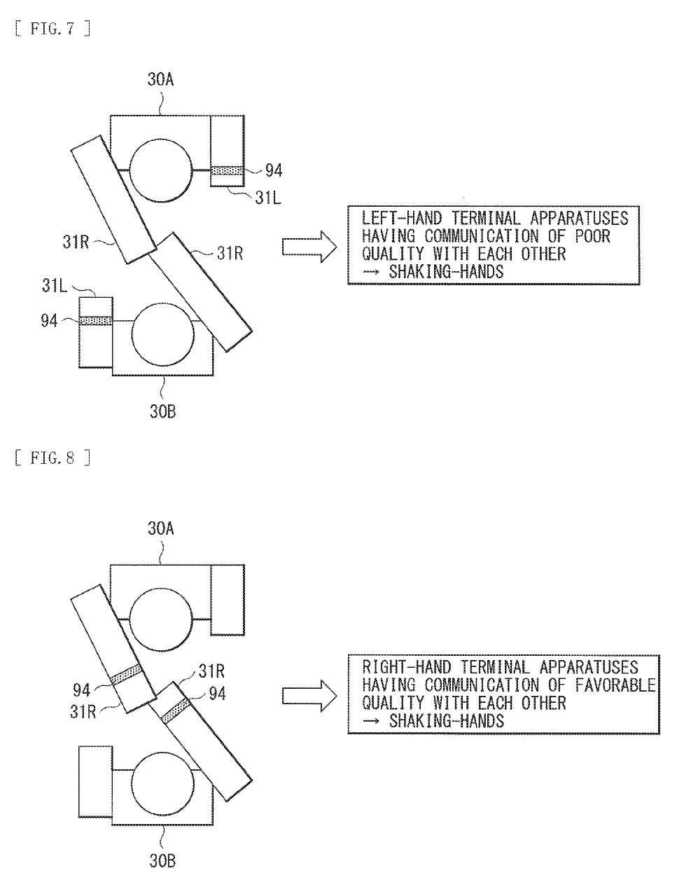

FIG. 8 illustrates an example in which the first terminal holder 30A and the second terminal holder 30B each have the wristband terminal 94 being attached as the terminal apparatus on the right hand 31R side. The first terminal holder 30A and the second terminal holder 30B both have the wristband terminals 94 being attached as the terminal apparatuses on the right hand 31R sides, and thus, in a case where the two terminal apparatuses perform communication of favorable quality with each other, the terminal apparatuses are able to recognize that the respective right hands 31R each on the side where the terminal apparatus is attached are used for shaking-hands.

FIG. 9 illustrates an example in which the first terminal holder 30A and the second terminal holder 30B each have the wristband terminal 94 being attached as the terminal apparatus on the left hand 31L side. The first terminal holder 30A and the second terminal holder 30B both have the wristband terminals 94 being attached as the terminal apparatuses on the left hand 31L sides, and thus, in a case where the two terminal apparatuses perform communication of medium quality with each other, the terminal apparatuses are able to recognize that the hand on the side where the terminal apparatus is attached and the hand on the side where the terminal apparatus is not attached are in a holding-hands state.

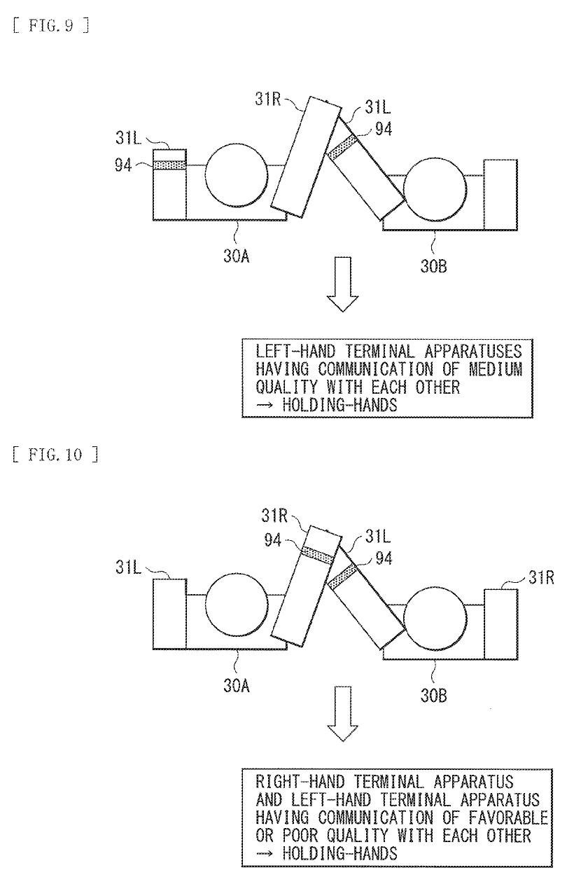

FIG. 10 illustrates an example in which the first terminal holder 30A has the wristband terminal 94 being attached as the terminal apparatus on the right hand 31R side and the second terminal holder 30B has the wristband terminal 94 being attached as the terminal apparatus on the left hand 31L side. In this case, in a case where the two terminal apparatuses perform communication of favorable quality with each other, the terminal apparatuses are able to recognize that the respective hands on the sides where the terminal apparatuses are attached are in a holding-hands state. Further, in a case where the two terminal apparatuses perform communication of poor quality with each other, the terminal apparatuses are able to recognize that the respective hands on the sides where the terminal apparatuses are not attached are in a holding-hands state. It is to be noted that FIG. 10 illustrates the case where the communication of favorable quality is performed.

In this way, utilizing the terminal apparatus and the apparatus system according to the present embodiment makes it possible to recognize shaking-hands or holding-hands. In this case, processing such as data exchange between the two terminal apparatuses may be performed on the basis of a recognition result. For example, in a case where it is possible to recognize shaking-hands, pieces of information such as each other's business card data may be exchanged.

### [1.4 Effects]

As described above, according to the present embodiment, because a position of a communication partner is determined on the basis of a state of communication using a human body as a communication medium, it is possible to determine the position of the communication partner by utilizing a human body communication technology.

According to the technology of the disclosure, the terminal apparatus is allowed to estimate a position of a device of a communication partner having no means of estimating a relative position or an absolute location. Because the human body communication is utilized, only touching the device of the communication partner by a person wearing the terminal apparatus makes it possible to distinguish the right or left position, etc. of the device of the communication partner. In a case of application to stereo pairing, only touching the speaker 95 with both hands by a person wearing the terminal apparatus is allowed to be an action of the person to be performed before completion of the pairing.

It is to be noted that the effects described in the foregoing embodiment and the like are illustrative and may have other effects. This holds true for effects of subsequent other embodiments.

### 2. Second Embodiment (an Example of Application to a Mobile Body)

The technology according to the present disclosure is applicable to various products. For example, the technology according to the present disclosure may be realized as an apparatus mounted to any kind of moving bodies such as a vehicle, an electric vehicle, a hybrid electric vehicle, a motorcycle, a bicycle, a persona mobility, an aircraft, a drone, a watercraft, a robot, construction equipment, and agricultural machinery (tractor).

It is to be noted that, in the following descriptions, GSM and HDMI are registered trademarks.

FIG. 11 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 11, the vehicle control system 7000 includes a driving system control unit 7100, a body system control unit 7200, a battery control unit 7300, an outside-vehicle information detecting unit 7400, an in-vehicle information detecting unit 7500, and an integrated control unit 76(X). The communication network 7010 connecting the plurality of control units to each other may, for example, be a vehicle-mounted communication network compliant with an arbitrary standard such as controller area network (CAN), local interconnect network (LIN), local area network (LAN), FlexRav. or the like.

Each of the control units includes: a microcomputer that performs arithmetic processing according to various kinds of programs; a storage section that stores the programs executed by the microcomputer, parameters used for various kinds of operations, or the like: and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 11 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 71(X) functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 70(X).

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

FIG. 12 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 79(X). The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 12 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 11, the description will be continued. The outside-vehicle information detecting unit 7400( ) makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400( ) may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an extemal connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM), worldwide interoperability for microwave access (WiMAX), long term evolution (LTE)), LTE-advanced (LTE-A), or the like, or another wireless communication protocol such as wireless LAN (referred to also as wireless fidelity (Wi-Fi), Bluetooth, or the like. The general-purpose communication I/F 7620 may, for example, connect to an apparatus (for example, an application server or a control server) present on an extemal network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN. Bluetooth, near field communication (NFC), or wireless universal serial bus (WUSB). In addition, the in-vehicle device I/F 7660 may establish wired connection by universal serial bus (USB), high-definition multimedia interface (HDMI), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 11, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 11 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

In the vehicle control system 7000 as described above, the terminal apparatus and the apparatus system according to the present disclosure are applicable to, for example, communication with the extemal environment 7750 such as a terminal that is present close to the vehicle via the general-purpose communication I/F 7620. Further, the terminal apparatus and the apparatus system according to the present disclosure are applicable to communication with the in-vehicle device 7760 such as a mobile device or a wearable device possessed by an occupant via the in-vehicle device 7760.

### 3. Other Embodiments

The technology according to the disclosure is not limited to the description of the foregoing embodiments, and may be modified in a variety of ways.

For example, the technology may have the following configurations.

(1)

A terminal apparatus including:

a communication unit that performs communication, using a human body as a communication medium, with a communicated terminal apparatus; and

a first position determination section that determines a position of the communicated terminal apparatus, on a basis of a communication state between the communicated terminal apparatus and the communication unit.

(2)

The terminal apparatus according to (1), in which the first position determination section determines a relative position of the communicated terminal apparatus with respect to an installation location of an own terminal.

(3)

The terminal apparatus according to (1) or (2), in which

the communicated terminal apparatus includes a first communicated terminal apparatus and a second communicated terminal apparatus, and

the first position determination section determines a relative position of the first communicated terminal apparatus and the second communicated terminal apparatus.

(4)

The terminal apparatus according to (3), in which the first position determination section determines a right-left relative position of the first communicated terminal apparatus and the second communicated terminal apparatus.

(5)

The terminal apparatus according to any one of (1) to (4), further including a measuring section that measures the communication state.

(6)

The terminal apparatus according to any one of (1) to (5), in which the communication state includes at least one of a packet error rate, a bit error rate, a signal level, and a transfer delay amount of transfer data transferred between the communicated terminal apparatus and the communication unit.

(7)

The terminal apparatus according to any one of (2) to (6), further including a second position determination section that determines the installation location of the own terminal.

(8)

The terminal apparatus according to any one of (2) to (7), further including a storage section that stores information of the installation location of the own terminal.

(9)

The terminal apparatus according to any one of (2) to (8), in which the installation location of the own terminal is an absolute location.

(10)

The terminal apparatus according to any one of (2) to (8), in which the installation location of the own terminal is a relative installation location in the human body.

(11)

The terminal apparatus according to (10), in which the relative installation location includes at least one of a right-left position, a front-back position, and an upper-lower position in the human body.

(12)

An apparatus system including:

a first terminal apparatus; and

a second terminal apparatus that performs communication with the first terminal apparatus,

the first terminal apparatus including
a communication unit that performs communication, using a human body as a communication medium, with the second terminal apparatus, and
a position determination section that determines a position of the second terminal apparatus, on a basis of a communication state between the second terminal apparatus and the communication unit.

This application claims the benefit of Japanese Priority Patent Application JP2016-147119 filed with the Japan Patent Office on Jul. 27, 2016, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A terminal apparatus comprising:
a communication unit that performs communication, using a human body as a communication medium, with a communicated terminal apparatus; and
a first position determination section that determines a position of the communicated terminal apparatus, on a basis of a communication state between the communicated terminal apparatus and the communication unit.

2. The terminal apparatus according to claim 1, wherein the first position determination section determines a relative position of the communicated terminal apparatus with respect to an installation location of an own terminal.

3. The terminal apparatus according to claim 1, wherein
the communicated terminal apparatus includes a first communicated terminal apparatus and a second communicated terminal apparatus, and
the first position determination section determines a relative position of the first communicated terminal apparatus and the second communicated terminal apparatus.

4. The terminal apparatus according to claim 3, wherein the first position determination section determines a right-left relative position of the first communicated terminal apparatus and the second communicated terminal apparatus.

5. The terminal apparatus according to claim 1, further comprising a measuring section that measures the communication state.

6. The terminal apparatus according to claim 1, wherein the communication state includes at least one of a packet error rate, a bit error rate, a signal level, and a transfer delay amount of transfer data transferred between the communicated terminal apparatus and the communication unit.

7. The terminal apparatus according to claim 2, further comprising a second position determination section that determines the installation location of the own terminal.

8. The terminal apparatus according to claim 2, further comprising a storage section that stores information of the installation location of the own terminal.

9. The terminal apparatus according to claim 2, wherein the installation location of the own terminal is an absolute location.

10. The terminal apparatus according to claim 2, wherein the installation location of the own terminal is a relative installation location in the human body.

11. The terminal apparatus according to claim 10, wherein the relative installation location includes at least one of a right-left position, a front-back position, and an upper-lower position in the human body.

12. An apparatus system comprising:
a first terminal apparatus; and
a second terminal apparatus that performs communication with the first terminal apparatus,
the first terminal apparatus including
a communication unit that performs communication, using a human body as a communication medium, with the second terminal apparatus, and
a position determination section that determines a position of the second terminal apparatus, on a basis of a communication state between the second terminal apparatus and the communication unit.
